(19) United States
(12) Patent Application Publication
(10) Pub. No.: US 2024/0267452 A1
(43) Pub. Date: Aug. 8, 2024

(54) MOBILE COMMUNICATION SYSTEM WITH WHISPER FUNCTIONS

(71) Applicant: Marthinus Johannes VAN DER WESTHUIZEN, Queanbeyan East (AU)

(72) Inventor: Marthinus Johannes VAN DER WESTHUIZEN, Queanbeyan East (AU)

(21) Appl. No.: 18/294,832

(22) PCT Filed: Aug. 23, 2022
(86) PCT No.: PCT/AU2022/050967

§ 371 Date: Feb. 2, 2024

(30) Foreign Application Priority Data
Aug. 24, 2021 (AU) 2021-107498
Sep. 23, 2021 (AU) 2021-107566
Oct. 31, 2021 (AU) 2021-258102

(51) Int. Cl. H04M 1/72403; G10L 15/02; G10L 15/25; G10L 21/0208; H04R 1/10

(52) U.S. Cl. CPC H04M 1/72403; G10L 15/02; G10L 15/25; G10L 21/0208; H04R 1/1016; G10L 2015/025; H04M 2250/52; H04M 2250/74; H04R 2460/13; H04R 2499/11

(57) ABSTRACT

Methods, devices and computer-readable medium are provided in the field of whisper communications features of mobile phones such as for communicating in noisy environments or wherein the users of the communication system require privacy. The invention provides for capturing elements of whisper communication including sound and lips information expressed by a first user and converting the elements of whisper communication into signals suitable for transmission over a communications network, transmitting the signals over the communication network, receiving the signals and reconverting the signals into elements of whisper communication and replaying the whisper communication such that it can be perceived by a second user. Embodiments include microphones in combination with dedicated lips cameras attached to mobile phones, sound equalization processing and extendable earphones and lip display means

### TECHNICAL FIELD OF THE INVENTION

The present invention generally relates to whisper communication systems, e.g. mobile phones with features specially adapted for whisper communications or communication in noisy environments.

### BACKGROUND OF THE INVENTION

This application is a national stage application, filed under 35 U.S.C. § 371, of International Patent Application No. PCT/AU2022/050967, filed on August 23 2022, which claims the benefit of Australian applications AU2021258102, AU2021107566 and AU2021107498, all of which, together with the respective documents that said documents incorporate, are incorporated herein by reference in entirety.

Modern mobile devices such as smartphones are wonderfully complex devices. More than merely providing a means of communicating by sound as with the original telephones from the 1800's, the present day smart phones can allow visual communication and provide a multitude of functions that were unthinkable back when the telephone was invented. The manufacturers of modern mobile phones are in a race to the bottom in their quest for achieving market share. To be competitive, modern phones include games, entertainment, style and whatever the manufacturers can think of to add. Progress in electronic components has resulted in components such as digital cameras and movement sensors being very cheap and being used for novel and/or novelty applications.

Notwithstanding, the original requirements of telephones are still relevant, viz to provide a reasonable sound output which the telephone user can use as part of a telephone conversation, or for listening to music or podcasts.

However, mobile devices such as smartphones are often used in noisy environments. For instance, when used in a construction site, the sound of machinery such as jackhammers may drown out the sound from the smartphone earpiece or the smartphone speaker. By using the speaker option in a smartphone, it may be possible to hear the conversation in a noisy construction site, or in a disco for example. However, sometimes the user is in a busy work environment where people talk a lot but wherein it would be desireable to hear the phone better but without making additional sound so as to not disturb other workers. Furthermore, the conversation may be private and the user of the smartphone may prefer a discreet method of listening with increased volume without giving bystanders the opportunity to eavesdrop in their conversation.

Furthermore, the user may want to listen to two sources of sound simultaneously which is possible because human hearing has the ability to discriminate between two sources of sound. However, for this purpose, the human hearing system must be helped by providing the sound from multiple directions, e.g. each ear must be fed a separate sound stream. The present inventor is not aware of any smartphone that can currently play sound in two seperate streams, e.g. music through the speaker and a phone call through an earphone connected to a jack, e.g. a 3.5 mm audio jack. The present inventor is also not aware of any smartphone with dedicated lips cameras as disclosed in the present application.

Application US20170155999A1 discloses a wired and wireless earset comprising a first earphone unit and a second earphone unit wherein the second earphone unit can be inserted into the auditory canal of the user and wherein the modes of the first and second earset are controlled, adapted for noisy environments, and appears somewhat resembling noise cancellation systems. However, the invention in US20170155999A1 does not appear to allow the user to press the earpiece into the ear while talking on the phone.

Application WO2013147384A1 discloses a wired earset that includes noise cancelling. In particular, this application appears to be similar to the invention in US20170155999A1 and also does not appear to allow the user to press the earpiece into the ear while talking on the phone.

Application US20070225035A1 discloses an audio accessory for a headset. This application appears to be related to the present invention. In US20070225035A1, there is provided a system that can combine two audio signals. However, US20070225035A1 does not disclose the present invention.

Application KR20180016812A discloses a detachable bone conduction communication device for a smart phone. This invention appears to be relevant to the present invention. In KR20180016812A, the bone conduction speaker is attached with a U-structure to an existing phone. However, KR20180016812A does not disclose the present invention.

Application US20190356975A1 discloses an improved sound output device attached to an ear. This invention focuses on the attachment mechanism to the ear. Whilst this application appears relevant to the present invention, it does not disclose the present invention.

Application US20060211910A1 discloses a bone anchored bone conduction hearing aid system comprising two separate microphones connected to two separate inputs of a hearing aid, and a microphone processing circuit in the electronic unit, processing the signals from the two microphones to increase the sound sensitivity for sound coming from the front compared to sound coming from the rear. One of the sound inlets being the frontal sound inlet which is positioned more in the frontal direction than the other sound inlet. The bone anchored bone conduction hearing aid system of the present invention has a programmable microphone processing circuit where the sensitivity for sound coming from the front compared to sound coming from the rear can be varied by programming the circuit digitally in a programming circuit. Whilst US20060211910A1 is relevant to the present invention, it does not disclose the present invention.

### SUMMARY

It is an object of the present invention to overcome or ameliorate at least one of the disadvantages of the prior art, or to provide a useful alternative.

In one exemplary embodiment, a method is provided comprising: capturing elements of whisper communication expressed by a first user and converting the elements of whisper communication into signals suitable for transmission over a communications network; transmitting the signals over the communication network; receiving the signals and reconverting the signals into elements of whisper communication and replaying the whisper communication such that it can be perceived by a second user; wherein the elements of whisper communication comprise sound information associated with phonemes of speech and image information of facial organs associated with phonemes of speech.

In further exemplary embodiments of the method, the capturing and converting is performed by means comprising at least one whisper sound microphone and at least one lips video camera; wherein the reconverting is performed by means comprising at least a whisper sound reproduction device and a lips display device; wherein the whisper sound microphone, the lips video camera, the whisper sound replay device and the lips display device are whisper features of a mobile telephone.

In further exemplary embodiments of the method, the lips video camera is located substantially near the at least one whisper sound microphone; wherein the lips video camera substantially captures only a mouth area of the first user when the mobile telephone is held in a normal position with a top portion of the phone close to the first user's ear and a bottom portion of the phone close to the first user's mouth.

In further exemplary embodiments of the method, the whisper sound replay device is an extendable earphone fixedly attached to the mobile telephone.

In further exemplary embodiments of the method, the whisper sound replay device is a bone conduction device.

In further exemplary embodiments of the method, images from the lips video camera are processed to identify phonemes from the shape of the mouth of the first user.

In further exemplary embodiments of the method, the signals are equalized by digital filtering and sound mixing for disambiguation of the transmitted whisper communication.

In another exemplary embodiment, an electronic device for whisper communication is disclosed, comprising: a means for capturing elements of whisper communication expressed by a first user and converting the elements of whisper communication into signals suitable for transmission over a communication network; a means for transmitting the signals over the communication network; a means for receiving the signals and reconverting the signals into elements of whisper communication and replaying the whisper communication such that it can be perceived by a second user; wherein the elements of whisper communication comprise sound information associated with phonemes of speech and image information of facial organs associated with phonemes of speech.

In further exemplary embodiments of the device, the capturing and converting is performed by means comprising at least one whisper sound microphone and at least one lips video camera; wherein the reconverting is performed by means comprising at least a whisper sound reproduction device and a lips display device; wherein the whisper sound microphone, the lips video camera, the whisper sound replay device and the lips display device are whisper features of a mobile telephone.

In further exemplary embodiments of the device, the lips video camera is located substantially near the at least one whisper sound microphone; wherein the lips video camera substantially captures only a mouth area of the first user when the mobile telephone is held in a normal position with a top portion of the phone close to the first user's ear and a bottom portion of the phone close to the first user's mouth.

In further exemplary embodiments of the device, the whisper sound replay device is an extendable earphone fixedly attached to the mobile telephone.

In further exemplary embodiments of the device, the whisper sound replay device is a bone conduction device.

In further exemplary embodiments of the device, the images from the lips video camera are processed to identify phonemes from the shape of the mouth of the first user

In further exemplary embodiments of the device, the signals are equalized by digital filtering and sound mixing for disambiguation of the transmitted whisper communication.

In another exemplary embodiment, a non-transitory computer-readable storage medium is disclosed storing computer-executable instructions that when executed by one or more processors, configure the one or more processors to perform operations comprising: capturing elements of whisper communication expressed by a first user and converting the elements of whisper communication into signals suitable for transmission over a communication network; transmitting the signals over the communication network; receiving the signals and reconverting the signals into elements of whisper communication and replaying the whisper communication such that it can be perceived by a second user; wherein the elements of whisper communication comprise sound information associated with phonemes of speech and image information of facial organs associated with phonemes of speech.

In further exemplary embodiments of the storage medium, the whisper sound replay device is an extendable earphone fixedly attached to the mobile telephone.

In further exemplary embodiments of the storage medium, the whisper sound replay device is a bone conduction device. In further exemplary embodiments of the storage medium, the images from the lips video camera are processed to identify phonemes from the shape of the mouth of the first user. In further exemplary embodiments of the storage medium, the signals are equalized by digital filtering and sound mixing for disambiguation of the transmitted whisper communication.

### BRIEF DESCRIPTION OF THE DRAWINGS

FIG. 1 illustrates an example of the prior art.

FIG. 2 illustrates an embodiment wherein the mobile device incorporates a whisper sound reproduction system in a utility format that reminds a user of a cigarette lighter.

FIG. 3 illustrates an embodiment wherein the mobile device incorporates a whisper sound reproduction system as a pull-out from a corner of the mobile device.

FIG. 4 illustrates another embodiment wherein the mobile device

incorporates a whisper sound reproduction system as a pull-out from a corner of the mobile device, wherein the pull-out is sideways slide out of the top of the mobile device.

FIG. 5 and FIG. 6 illustrate embodiments wherein the mobile device incorporates a whisper sound reproduction system as a pull-out from a corner of the mobile device, wherein the pull-out is sideways from the body of the mobile device, in FIG. 6 the device includes a large surface area for impedance matching.

FIG. 7 illustrates an an embodiment wherein the mobile device incorporates a whisper sound reproduction system as embedded in a corner of the mobile device.

FIG. 8a illustrates an an embodiment wherein the mobile device incorporates a whisper sound reproduction system as embedded in a corner of a phone casing of the mobile device (aftermarket solution).

FIG. 8b illustrates the back of the embodiment of FIG. 8.

FIG. 9 illustrates a circuit diagram relevant to the present invention.

FIG. 9-A illustrates an embodiment as a concept demonstrator prototype that was used for developing the present invention. FIGS. 9-A (a)(g)(h) illustrates how Canny algorithm image processing was performed on a PC hardware-in-the-loop emulator to develop the WhisperPhone app. FIGS. 9-A(b)-(f) illustrates the concept prototype with a sound reproduction system (b) pivotably attached to the top of a prior art case for a smart phone (c), showing the back with a circuit board attached to a prior art case for a smart phone (d) and with two different pivotably attached camera/mic units at the bottom of a prior art case for a smart phone (d)-(f), the camera in (f) includes illumination LEDs and a gimballed arrangement for optimally orienting and positioning the lips camera. In FIG. 9-A(d), a prototype circuit board is shown on the back of the modified casing shown in FIG. 9-A(c). The output device in FIG. 9-A(b) is pivotably attached to the modified casing in FIG. 9-A(c), and the modified casing in FIG. 9-A(c) also includes a 3.5 mm jack in the bottom left corner. The modified casing is made from a flexible plastic material which allows the jack to be inserted while the casing is clipped on to the mobile device. The lips image is shown in FIG. 9-A(h) of the lips image in FIG. 9-A(g) as a Canny feature extraction which requires orientation before classification.

FIG. 9-B/C illustrate respectively algorithms for a capture and transmission subsystem and a reception and output subsystem flow chart with functions/modules adapted for the present invention. The functions/modules in FIG. 9-B/C are executed iteratively and repeatedly during the use of the whisper communication system, so that the functions can operate in a pipe-lined parallel fashion so that e.g. the transmission function can handle the data from a previous cycle in a parallel image capture function so that the sequencing of the function blocks are merely examples.

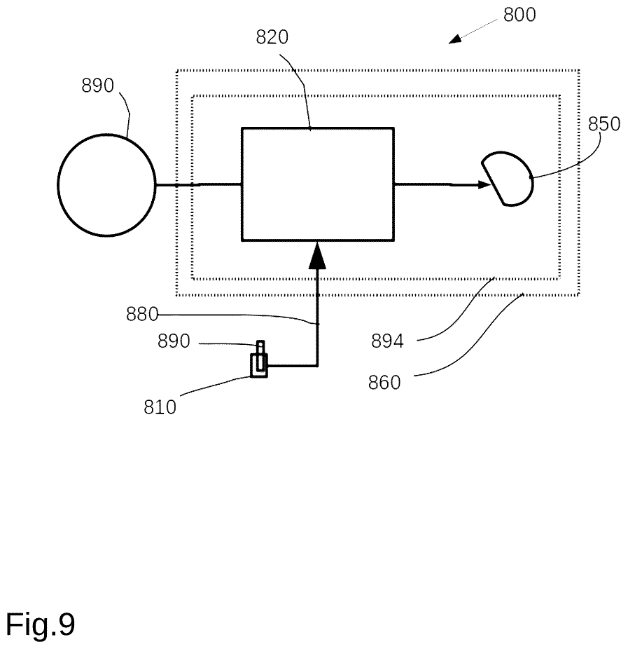

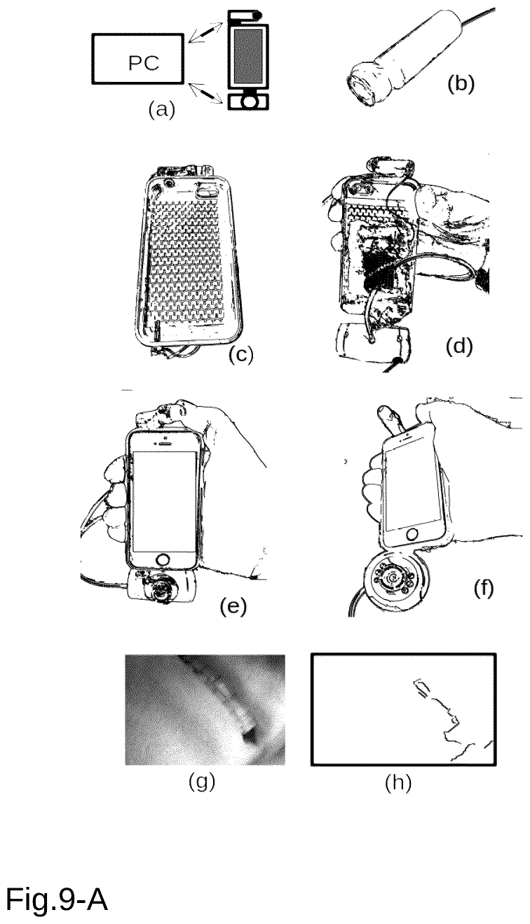

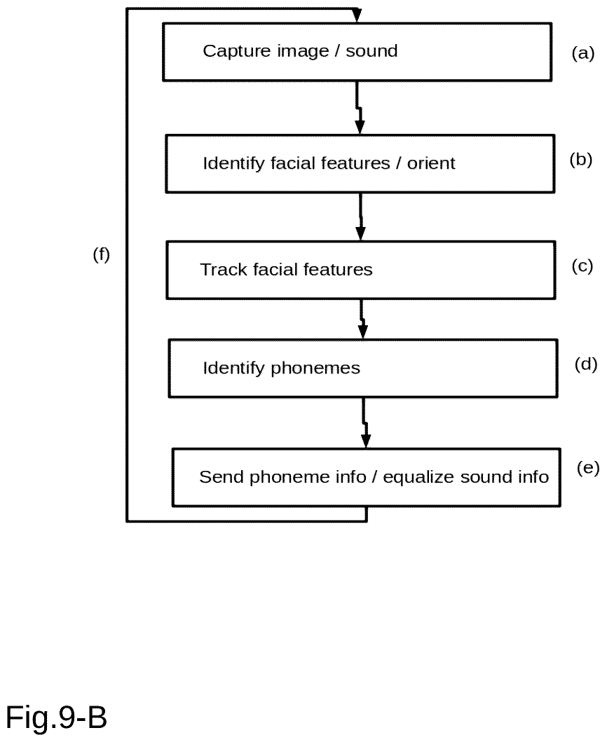

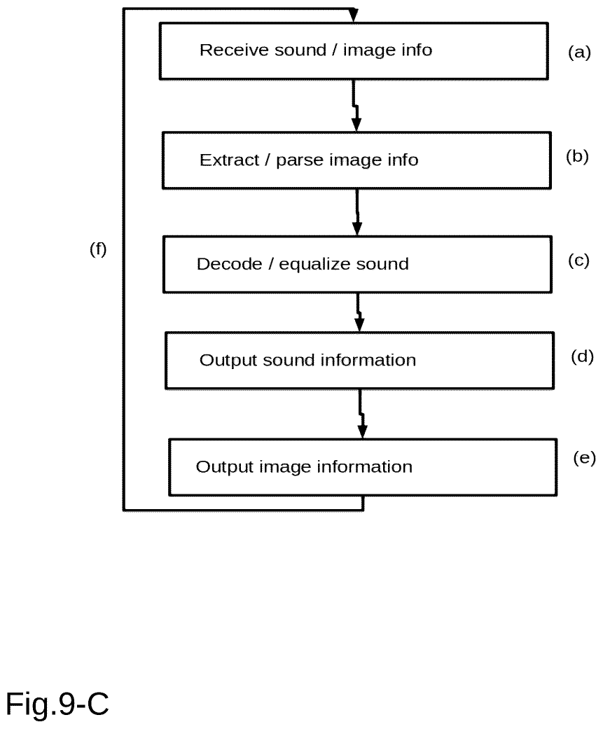

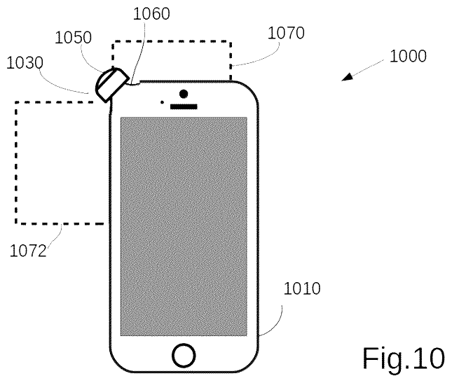

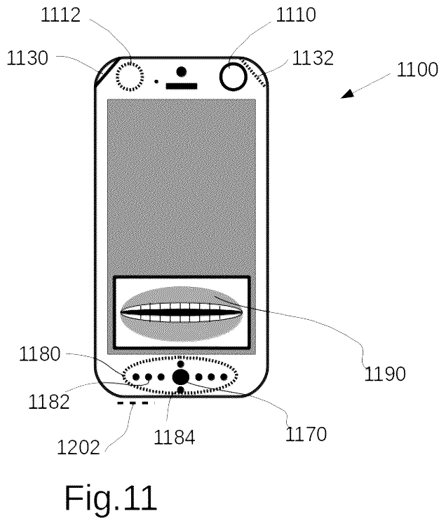

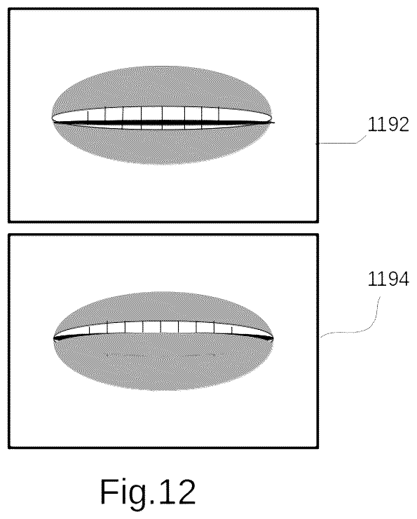

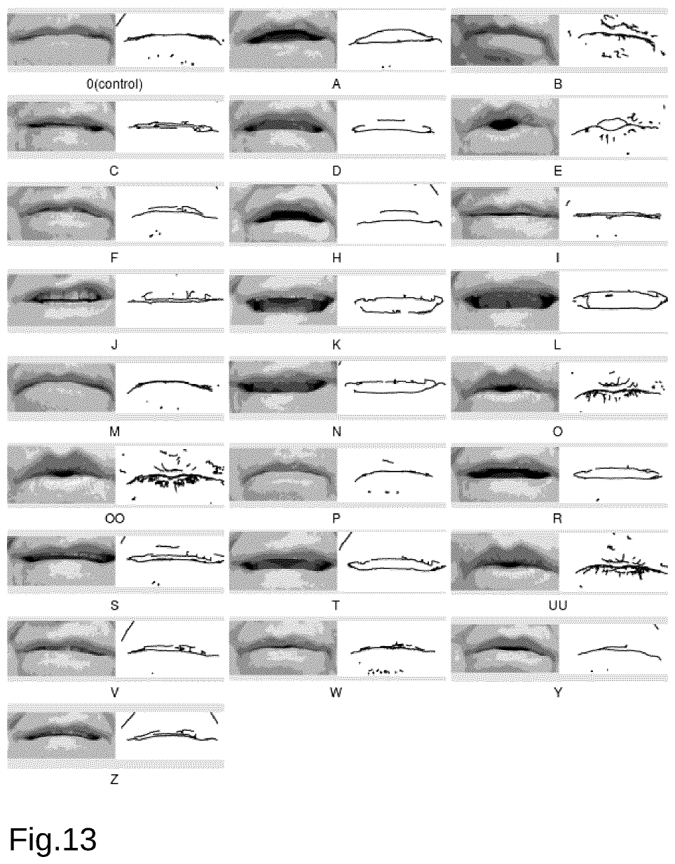

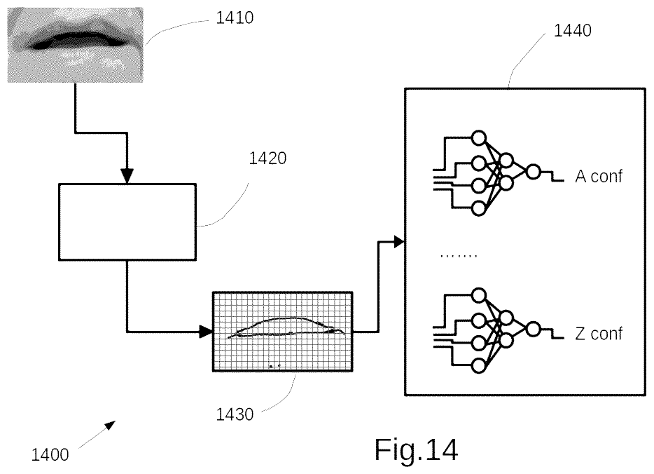

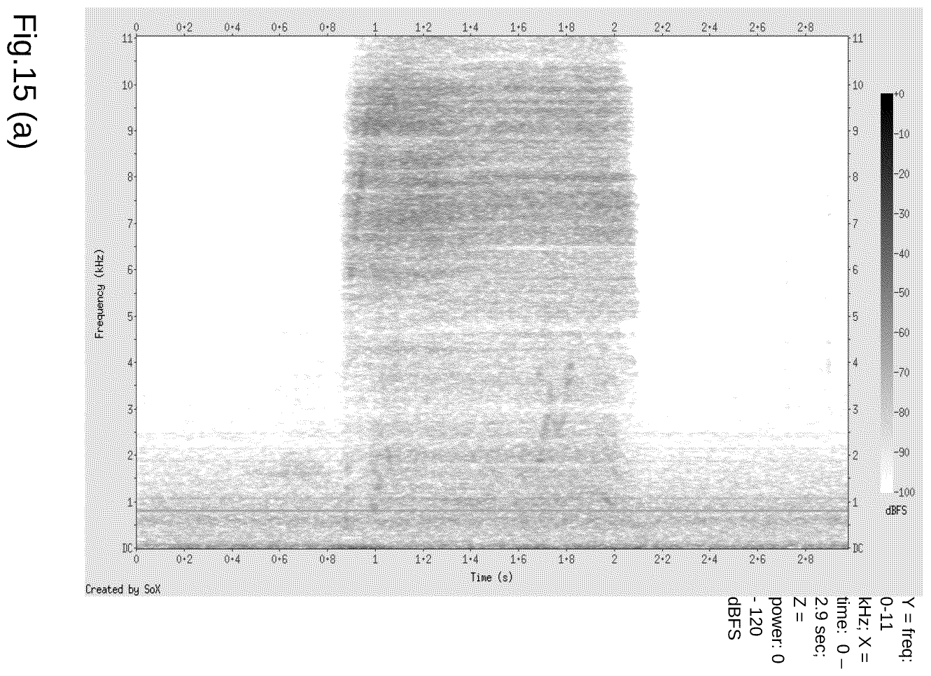

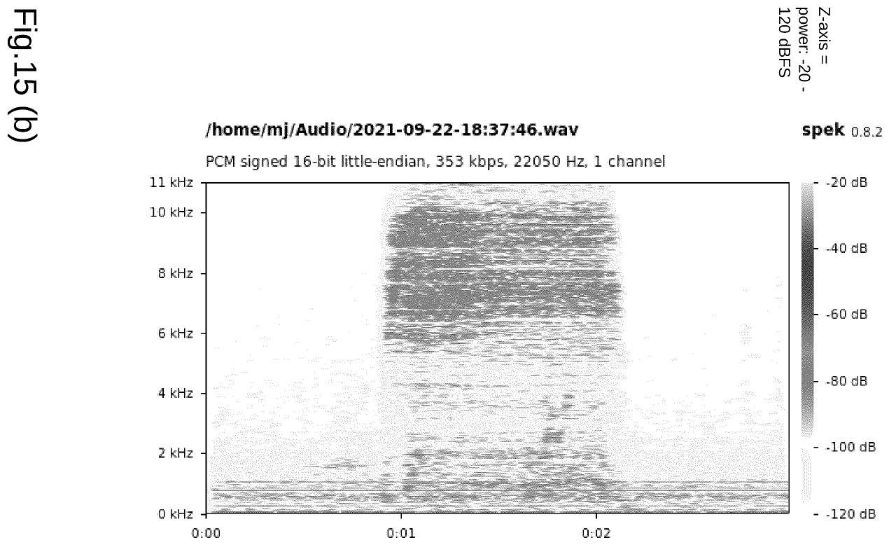

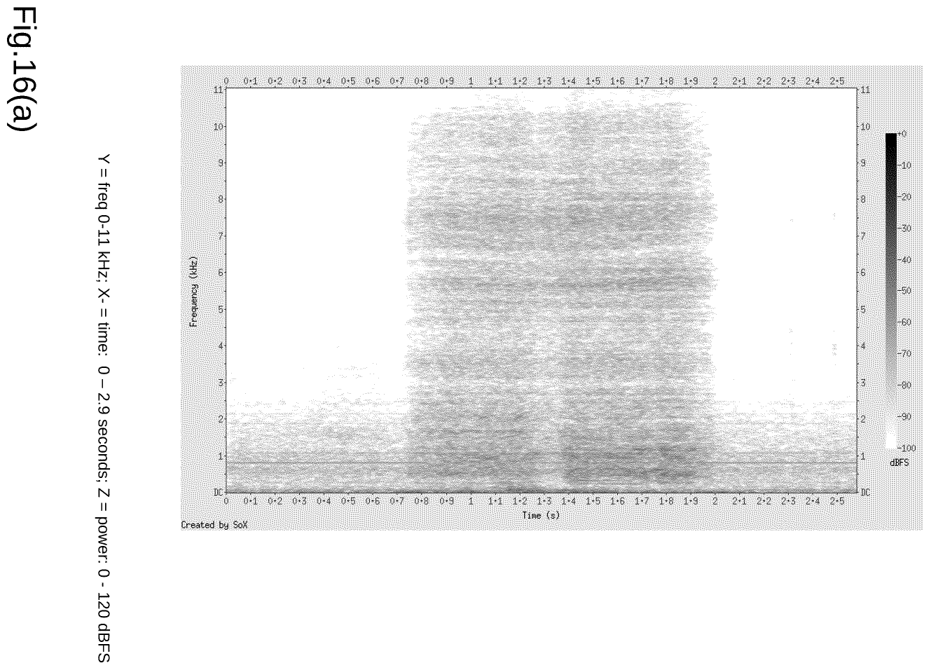

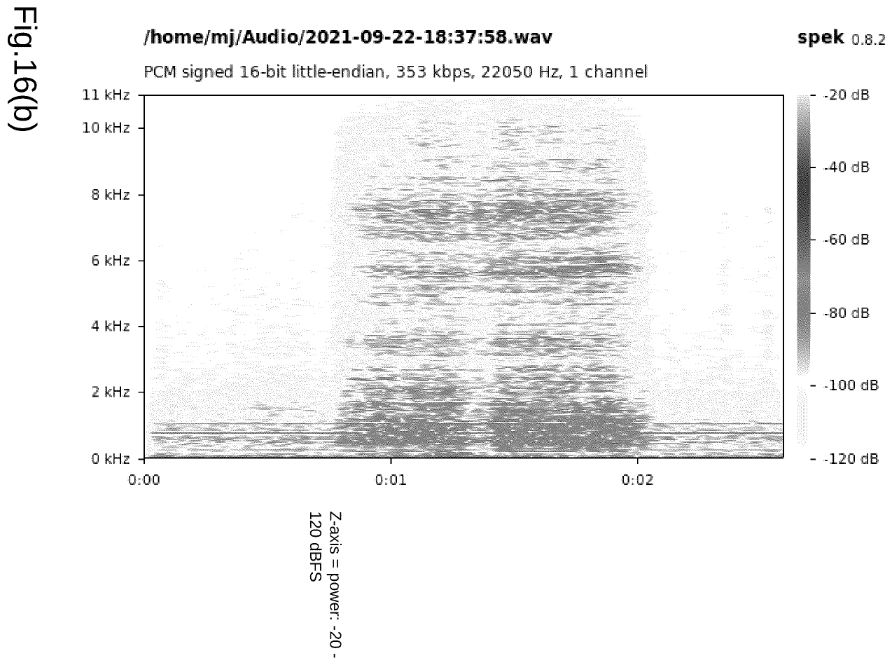

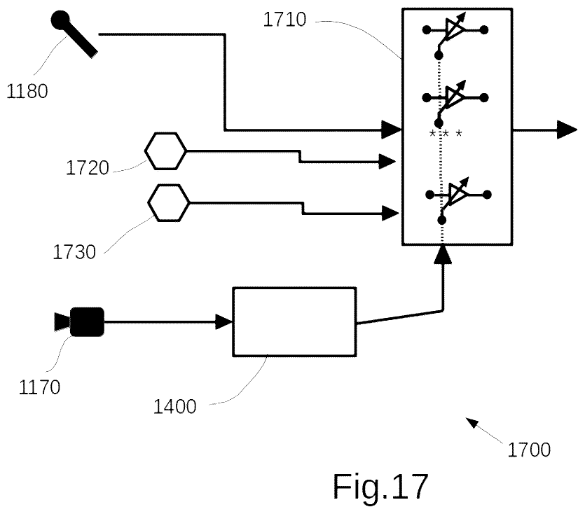

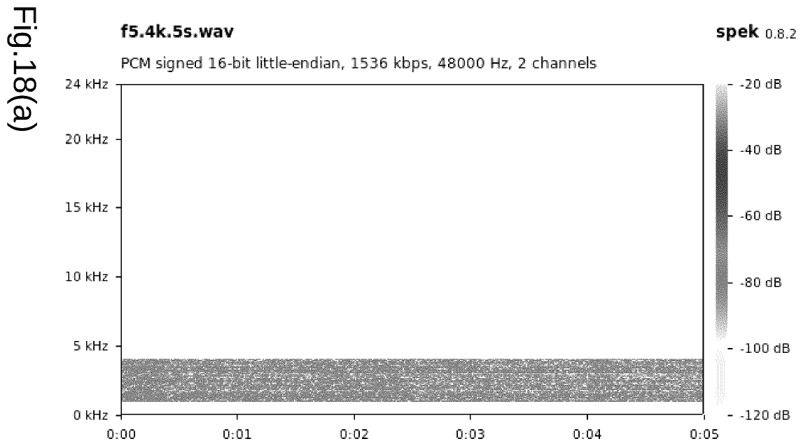

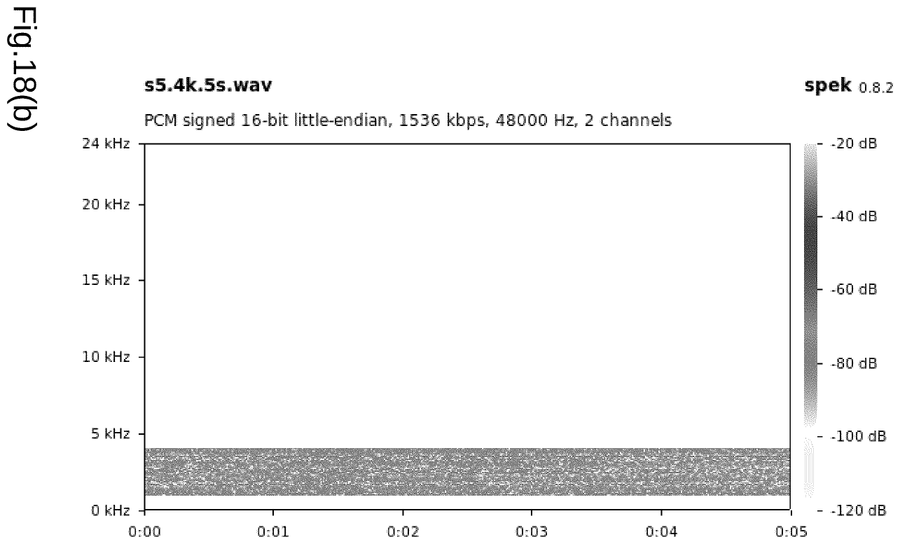

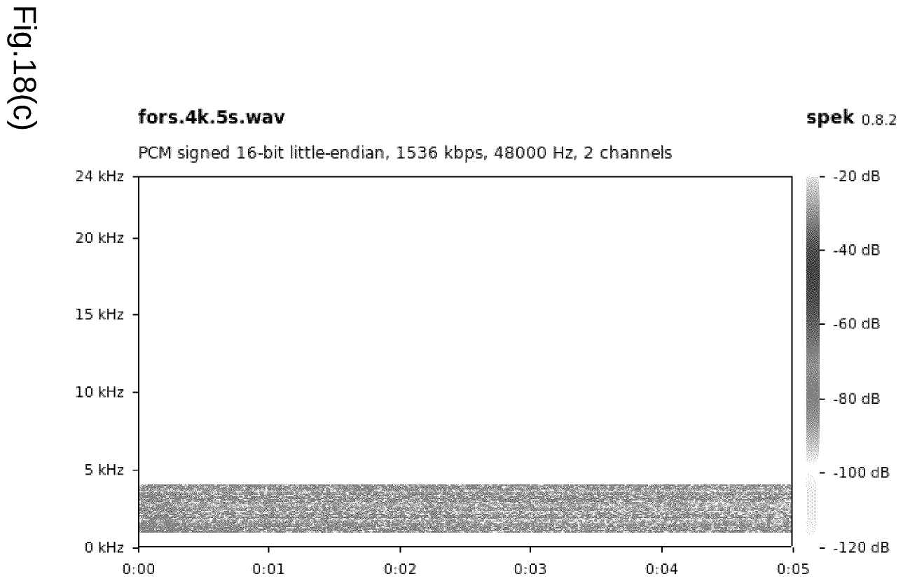

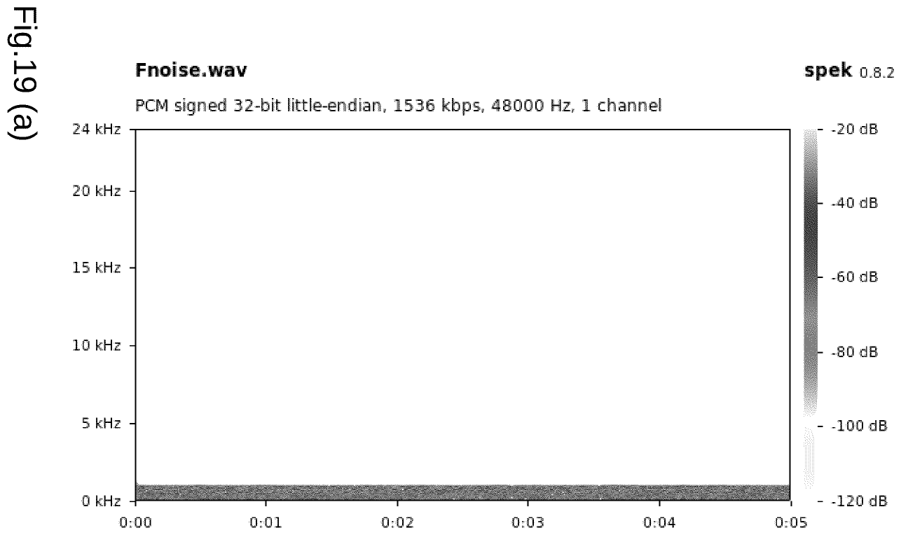

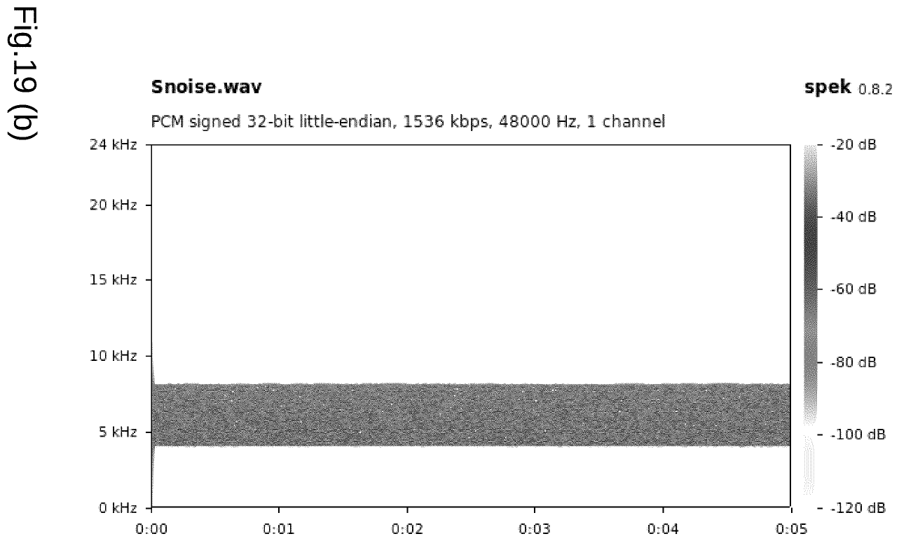

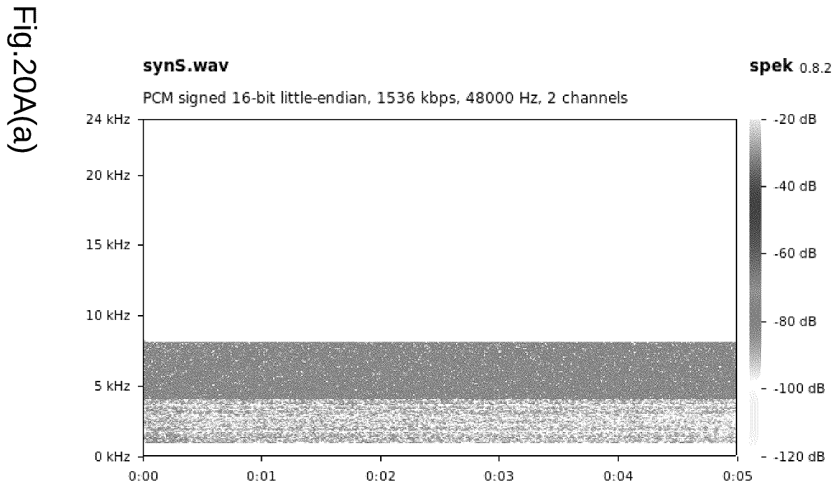

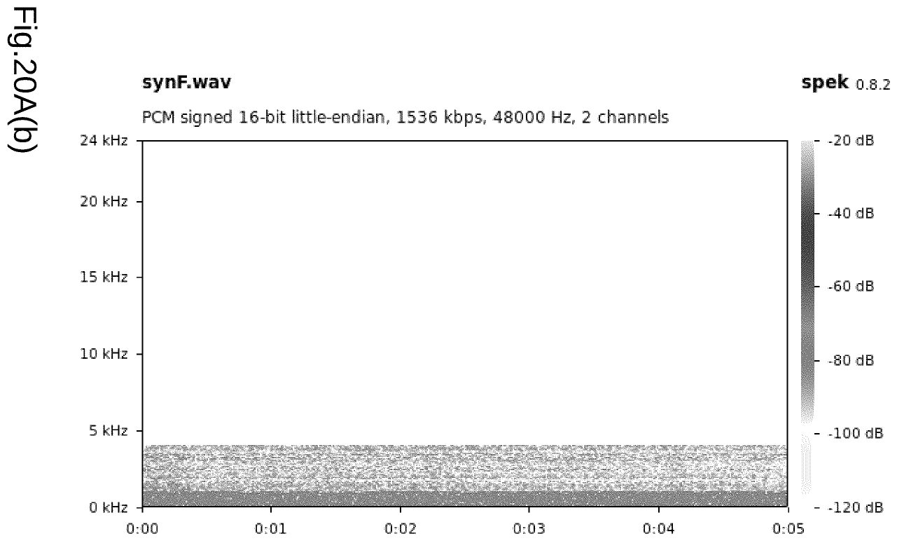

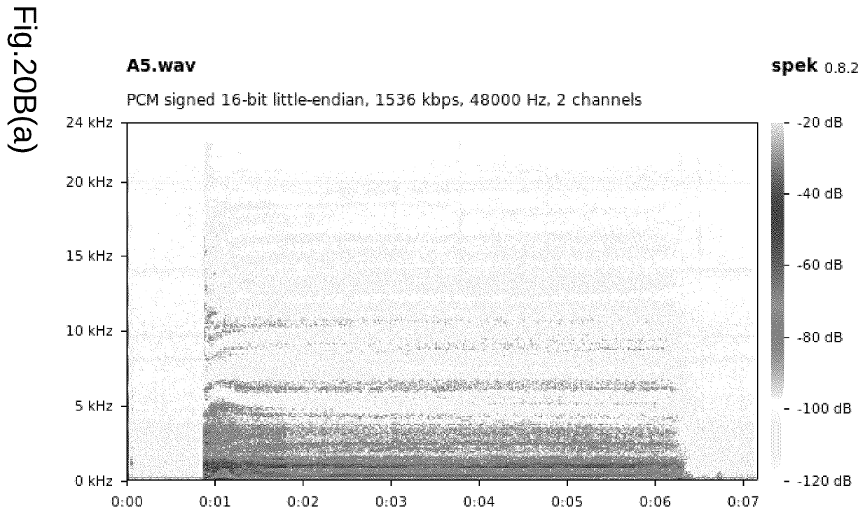

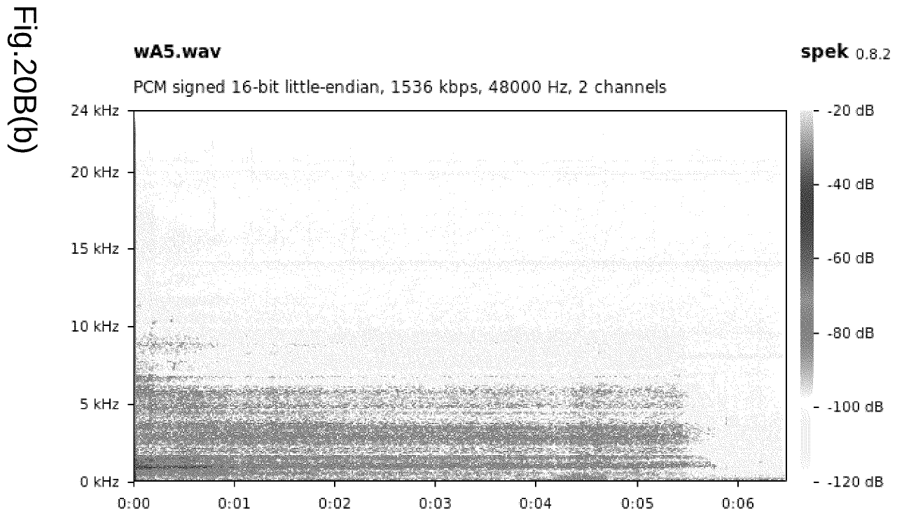

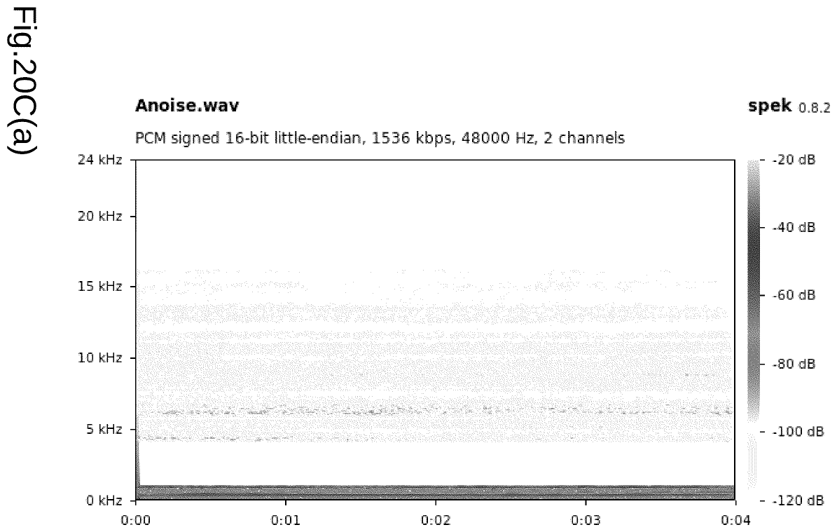

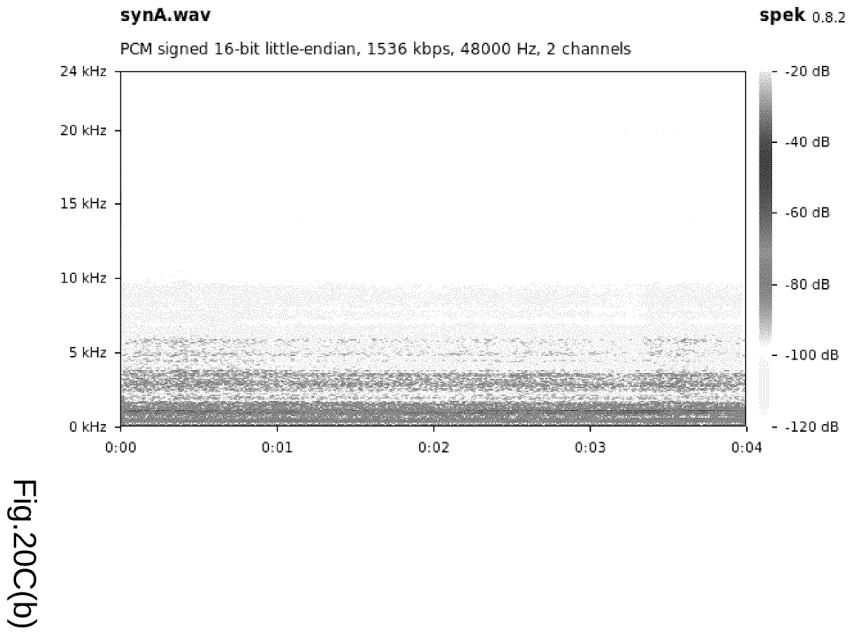

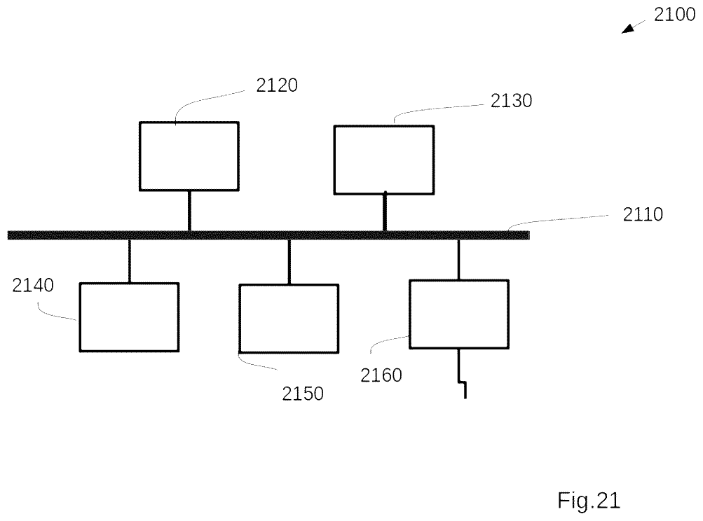

A person skilled in the art would also be aware that the functions can be grouped and/or combined in data structures and modules without changing the overall operation of the subsystems. A person skilled in the art would also be aware that the each function/module may be implemented as a software ebject or as a dedicated hardware module, e.g. by using the VHDL hardware language. A person skilled in the art would also be aware that the modules/functions may operate at different rates, e.g. the facial feature capturing (e.g. lips camera images) may operated at a different rate than the sound capturing because head movements are generally slower that the rate at which speech is generated or processed (in this application, the term ‘lips camera’/‘lips display’ implies a camera/display that also monitors other facial organs such as teeth and the tong). Some of the functions/modules are also optional, e.g. orienting the images may be unnecessary when the user is made aware or required to hold their head in a particular orientation with respect to the camera. A person skilled in the art would also be aware that the features in FIG. 9-B/C may be implemented on a single mobile device or on multiple mobile devices, but that most embodiments should have both capturing/sending as well as receiving/outputting features on a single mobile device.

FIG. 10 illustrates an embodiment with a fixed whisper sound reproduction system at an extremity such as a corner of a smart phone and optional flaps to cower the whisper sound. The sound reproduction system 1060 may also be conformally integrated into the smart phone mobile device such that it is inconspicuous, e.g. in a corner of the mobile device. The flaps may be dedicated flaps or be part of a structure such as a smartphone holder.

FIG. 11 illustrates an embodiment with a lips camera with optional visible light and/or IR illumination LEDs around the camera and an optional lips display.

FIG. 12 illustrates an embodiment of optional lips information being displayed on the display of a mobile device, which also illustrates how teeth pixel counting can be used to classify lip positions. The lips information is thus generated from sounds and images.

FIG. 13 illustrates the Canny image processing of lips camera images in a normalized horizontal orientation for a subset of phonemes corresponding to the English alphabet. In FIG. 13, images A-Z can be used for inputting lip information, or can be shown to output lip information.

FIG. 14 illustrates an embodiment of the lips analysis image processing algorithm in a block diagram format.

FIG. 15-16 illustrate spectrograms used in the development of the present invention.

FIG. 17 illustrates an embodiment of the algorithms used in the whisper voice signal processing algorithms in block diagram format.

FIGS. 18, 19, 20-A, 20-B, 20-C illustrates spectrograms used in the development of the present invention.

FIG. 21 illustrates a block diagram of a computer system is shown that may be used to implement features of some embodiments of the disclosed invention.

### DETAILED DESCRIPTION

When a smartphone user is in a busy work environment where people talk a lot, in can be desireable to hear the phone better but without making additional sound so as to not disturb other workers. Furthermore, the conversation may be private and the user of the smartphone may prefer a discreet method of listening with increased volume without giving bystanders the opportunity to eavesdrop on their conversation.

The present invention also relates to improvements in mobile device sound output. The improvements can be integrated into the mobile devices or can be provided as an aftermarket add-on by e.g. smartphone cases.

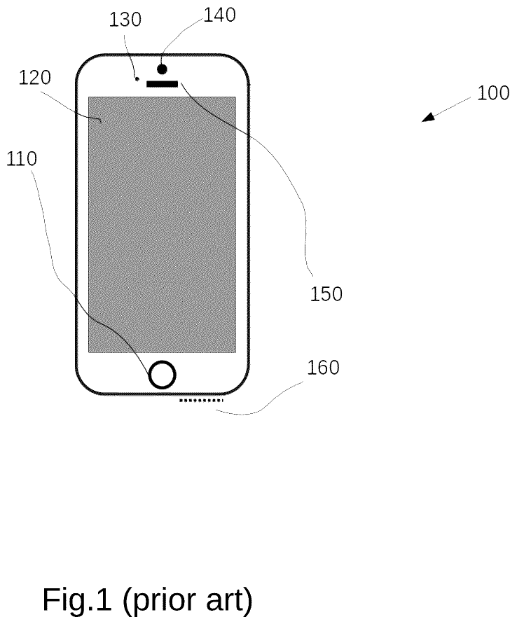

In FIG. 1, a prior art smart phone 100 is illustrated. The smartphone 100 comprises a display 120, a button/fingerprint reader 110, a front camera 140 and a proximity sensor 130. Of particular concern in the application, are the two sound output devices 150 and 160. Sound output device 150 is near a proximity sensor 130 and is used when the ear is close to the top of the phone. Sound output device 160 is a speaker.

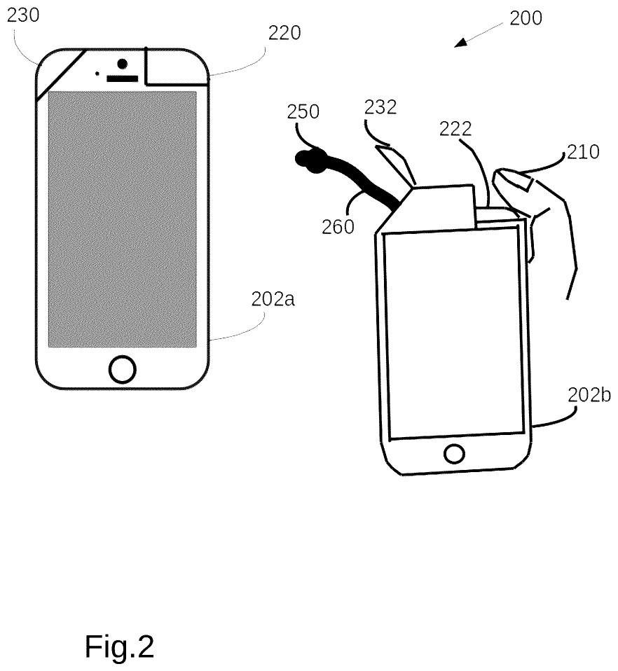

In FIG. 2, an embodiment 200 of the present invention is shown. Smartphone 202a comprises a flap 230 which can be opened by pressing on corner 220 by user finger 210 which changes the state of phone 202a into phone 202b which includes a pull-out output sound device 250 on a flexible conductor 260.

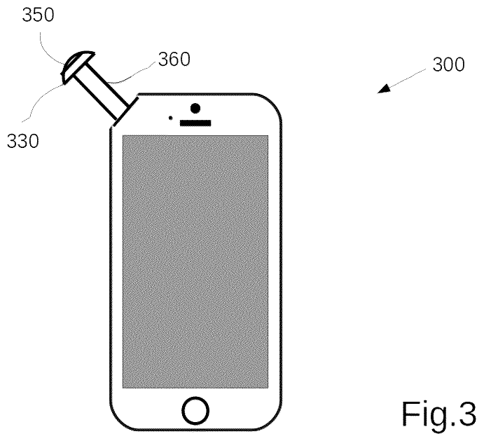

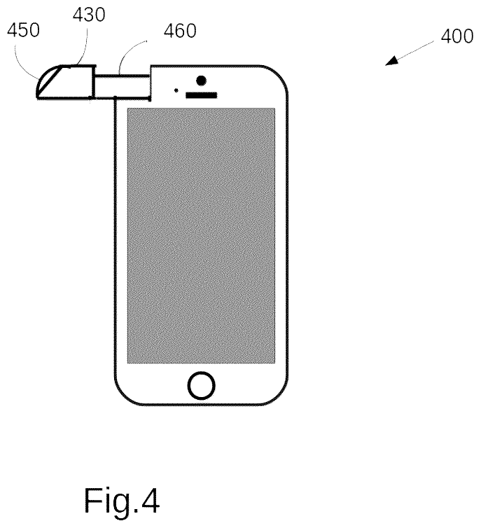

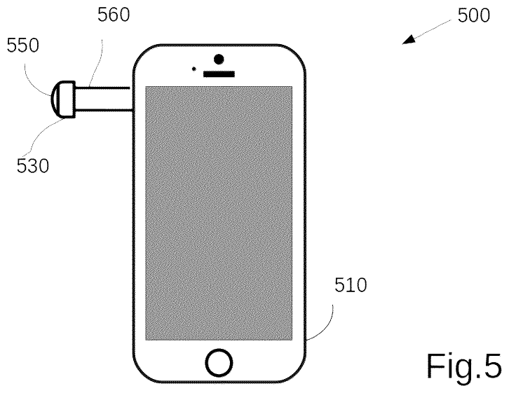

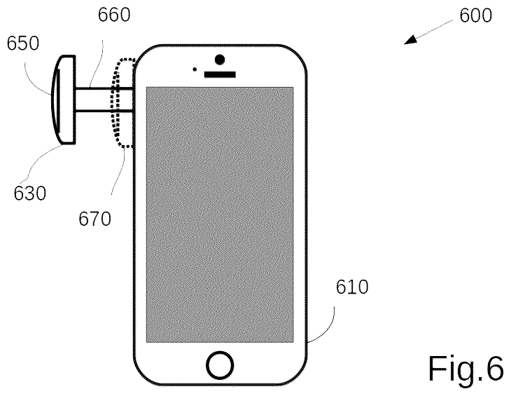

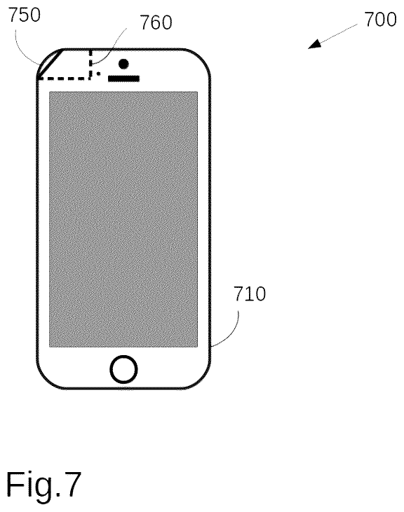

In FIG. 3 to FIG. 7, various alternative embodiments are shown of the present invention. In FIG. 7, the sound output device 750 is located in a corner and built into the housing of the smartphone. The sound output device may be isolated from vibration by acoustic prevention means 760, e.g. sound proof tape or sound proof foam. In another embodiment, means 760 can be meta materials that allow movement in one dimension only. In another embodiment, means 360, 460, 560, 660, 760 may be removably connected, e.g. by Bluetooth connection by removal from the mobile device and by insertion into an ear of the user, as well as being able to be recharged when re-inserted into the mobile device.

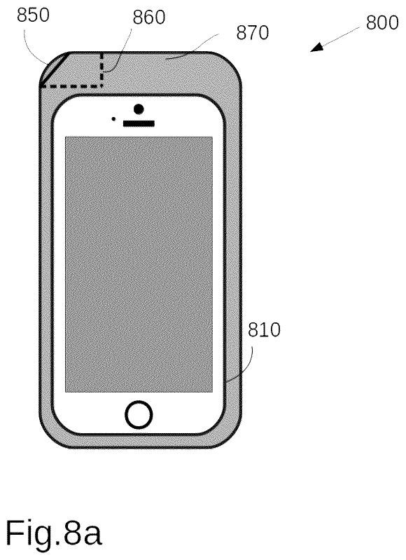

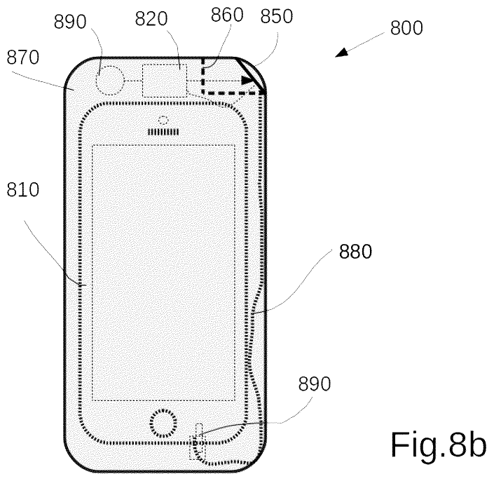

In FIG. 8a and FIG. 8b, another embodiment is shown wherein the whisper sound output device is incorporated into an after-market smartphone casing (FIG. 8a shows the front, FIG. 8b shows the back). The whisper sound reproduction system optionally includes a wired connection 880 from the output device 850 to an earphone jack 890. Alternatively or additionally, a powered circuit 820 is used to connect with a wired connection 880 from the jack 890. Alternatively or additionally, a wireless connection can be used instead of wired connection 880 (e.g. Bluetooth). Power supply means 890 may be a replaceable battery or a rechargeable battery.

In FIG. 9, the circuit diagram of and embodiment of the present invention is disclosed. When the whisper sound output device is integrated into a smartphone, then power supply 890 may be the same power supply used by the mobile device. Circuit 820 may be integrated into the circuit of the mobile device. The electric-signal-tosound converter 850 may be galvanically connected to circuit 820, or be connected wirelessly, e.g. by Bluetooth, or Bluetooth Low Energy, and said converter 850 may be charged from the power supply 890. Optionally, when the circuit in FIG. 9 is located on an external casing, the casing may perform as a source of power for the mobile device, e.g. by galvanic connections (e.g. USB or Lightning or custom electrical contact regions) between the casing and the housing of mobile device, or by wireless connection such as by inductive power transfer. Mobile casing or circuit 820 may also include its own data communication links, e.g. WiFi links, thus allowing the casing to act as a portable docking station.

Alternative or additionally, the circuit 820 and the electric-signal-to-sound converter 850 may be integrated into a module, e.g. the Adafruit Product 1674, which is a bone conduction module suitable for non-air sound reproduction (https://web.archive.org/web/20210226065909/https://www.adafruit.com/product/1674). Bone conduction speakers differ from air sound conduction devices by their relative impedance in much the same way that a air sound wave speaker differs from an underwater speaker. Thus, the sound is conducted in the listener's bones but it is still sound. With appropriately adjusted impedance matching, the electrical input to the bone conduction speaker and the air conduction speaker can be viewed as being equivalent. In some embodiments, the bone conduction device may be combined (e.g. for economy reasons) with the phone vibrator that is commonly used to alert a user without making air sounds.

The modules disclosed in this application can be implemented by, for example, using software and/or firmware to program programmable circuitry (e.g. microprocessor), or entirely in bespoke hardwired (non-programmable) circuitry, or in a combination of such forms. Bespoke hardwired circuitry may be in the form of, for example, one or more FPGA, PLDs, ASICs, etc.

In this specification, the term ‘embodiment’ means that a specific feature described relating to an embodiment is encluded in at least one embodiment and specific references to an ‘embodiment’ does not imply that all such references refer to the same ‘embodiment’. All examples provided in this specification are illustrative only and it is not intented to limit the scope and meaning of the disclosures. Persons skilled in the art will appreciate that the programs and flow diagrams provided in this application may be performed in series or in parallel, and may be performed on any type of computer.

The scope sought by the present application is not to be limited solely by the disclosures herein but has to be broadened in the spirit of the present disclosures. In the present application, the term ‘comprise’ is not intended to be construed as limiting and the disclosure of any reference should not be construed as admitting anticipation. All patents, applications and citations referred to in this description are included herein in their entirety.

In this application, the term whisper sound reproduction system is used to denote a sound reproduction system that can be used to play back sound that is very quiet or sound that is not necessarily quiet but that can be played back in a noisy environement, or be used by hearing-impaired users or users who may wish to simultaneously listen to two separate streams of sound. The whisper sounds may be produced online or be recorded and stored and subsequently be played back after being stored. The whisper sounds may also include voiced sounds, natural sounds or instrumented sounds of low volume so that they can be played back by aspects of the present invention. It is envisaged that the whisper sound capture and reproduction system may be integrated into mobile devices (telephones) or be made available as an aftermarket clip-on device (e.g. a ‘smart’ phone casing).

FIG. 10 illustrates another embodiment of the present invention. In this embodiment, the phone 1010 has a sound output device 1030 comprising an earphone or other sound converter 1050 and a flexible or rigid extension 1060. Optionally, a flap can extend from the phone and act as a noise shield in noisy environment, the flap can slide out horizontally 1072 or vertically 1070, or swivel out, e.g. a round flap swiveling on the back of the phone (not shown).

FIG. 11 illustrates another embodiment of the present invention. In this embodiment, the button/fingerprint reader 110 in FIG. 1 is moved from the bottom position to position 1110 where it can conveniently be pressed by the thumb of the hand while the other fingers of the hand hold the phone. Alternatively or additionally, the button/fingerprint reader can be moved to the left position 1112 which may be more convenient for left-handed users. That is, the device can be supplied with one or two button/finger print readers, and when supplied with two buttons/fingerprint readers, the user may select either in parallel or by a phone setting. As a person skilled in the art will know, the buttons/fingerprint readers may be soft buttons on a tactile sreen. Likewise, the sound output device 1130 may be moved to the right position 1132 for left-handed users, or be duplicated in position 1132 so that the user may select or set the sound output device as convenient to the user.

In FIG. 11, in the place where the button/fingerprint reader was in the prior art phone in FIG. 1, a microphone group 1180 can be configured. The microphone group 1180 may be in addition or in place of other microphones, e.g. microphone 1202 or the back microphone (not shown). Multiple microphones (including microphone arrays) are used in prior art smartphones to perform echo cancellation and noise cancellation and can be incorporated in the present invention. The microphone group 1180 optionally comprises a facial organ (e.g. lips, teeth, tongue) camera 1170. The camera 1170 is also referred to as a ‘lips camera’ in this specification, but it is may also be used for taking images of the tongue, teeth or mouth. Selectively, the user can display an image taken by the lips camera 1170. By using a lips camera, e.g. instead of the front camera 140 in FIG. 1, the user can be assured that their face is not recorded for privacy reasons. Lips camera 1170 may be a single unit, or may be an array of lips cameras, in which case the lips camera may take 3D pictures. The image 1180 of the lips camera 1170 can optionally be displayed on the display of the present phone, or alternatively or additionally be sent over to the other party's phone with which the present inventon phone 1100 is in communication, for display on the other party's phone screen. Whilst this feature may have a novelty effect, it may also help the other party understand the conversion, e.g. when the user of phone 1100 is whispering.

In the microphone group 1180, item 1184 may be a microphone part of the array of microphones including item 1182. Alternatively or additionally, item 1184 may be a, or one of a plurality of, illuminating devices. When item 1184 is an illuminating device, it may be purposed to provide lighting for lips camera 1170. Alternatively or additionally, lips camera 1170 may operate in a range of light wavelenghts that are not visible to the human eye, e.g. infrared or ultraviolet. Beneficially, when lips camera 1170 is operated in a spectrum band that is not visible to the human eye, e.g. infrared (IR), then item 1184 may be an IR illumination device, e.g. an IR LED. In this way, the lips camera may operate in darkness and in lighted environments.

Alternatively or additionally, the lighting device 1184 may be used for purposes other than illuminating for the lips reading camera, e.g. by providing reddish light when taking ‘selfie’ pictures, or when operating telephonic conversations in video mode, so that a more attractive picture of the person in front of the phone results, as is it is known by professional photographers that red light makes people look more attractive. As another example, by illuminating with light with a UV component, illuminescence effects from makeup may be observed, or sparkles from glitter makeup components. In other embodiments, the means for providing face illumination may be from illuminators positioned not within the microphone group, e.g. the illumination means can be positioned at the top of the mobile device, or on the sides, e.g. one LED on either side of the screen. As is known by professional photographers, lighting effects may have an important aesthetic effect, e.g. using lighting colour hues that best match the skin tone of the speaker, or cameras that take pictures from the most flattering angle.

By showing the lips of the speaker to the other party, the voice of the sender (the user) may be more intelligible, without the user needing to send full facial information. Some users may at times prefer not to show their face during a telephone conversation, e.g. for reasons of privacy or shyness. Alternatively or additonally, the picture of the lips camera may be used as a means of personalized (e.g. intimate) communication.

As has been shown by the experience of people that are born deaf, a visual picture of the movement of lips convey a large amount of information which can be used to decypher a voice conversation. Althernatively or additionally, the lip visual information may be processed automatically, i.e. automatic voice enhancement. The automatic processing may be performed locally (i.e. at the speakers phone), or remotely (e.g. at the receiver/listeners phone, or via a server between the speaker and the receiver, e.g. VOIP servers such as Skype or Whatsapp). By processing the lip visual information on a server, phones which may not have been designed for using visual cues from the speaker's lips may also benefit from the invention. When the mobile device is not equipped with a lips camera, the ordinary face camera with appropriate software may be used, and the present invention may be performed by an app without requiring hardware changes to existing mobile devices. The microphone group can include a microphone 1184, and/or multiple additional microphones e.g. 1182, so that the multiple microphones may optionally form an array. In FIG. 11, an example of such a microphone array is shown as a cross with one microphone respectivly above and below the lips camera 1170, and three microphones respectively to the left and the right of the lips camera 1170. The configuration of the microphone array may be in any other form, or there may be only one microphone in microphone group 1180.

Optionally, alternatively or additionally, the moving picture taken by the lips camera 1170 can be combined with the picture of the front camera in order to extract information from the mouth of the user of phone 1100, e.g. when the user is whispering. Optionally, a 3D analysis of the lips can be performed, e.g. by combining the image information from a plurality of cameras. Optionally, all lips image processing may be performed by the face camera. Optionally or additionally, by using information from anyone of the lips camera 1170, the front camera 140 in FIG. 1, or a combination of cameras, the voice information of the user of phone 1100 that is received via any microphone (e.g. from the microphone group 1180 or the microphone at the bottom 1202 or at the back (not shown)) can be enhanced and sent more clearly to the listening party's phone. A person skilled in the art would also refer to the process of combining the lips camera information with sound information as a sensor fusion of image data and sound data, e.g. for disambiguation or sound shaping. In FIG. 12, a stylised example is shown of pictures taken from the lips camera and shown on the screen of the mobile device. The lips camera pictures may distinguish between phonemes by analysing the shape of the mouth during speaking, e.g. 1192 may be an ‘s’ sound, and 1194 may be an ‘f’ or ‘v’ sound. In some embodiments, the lip images are the real images taken by the lips camera. In other embodiments, the lip images are the real images that have been signal processed, e.g. colours may be enhanced or changed, or grayscales or colour depth may be changed, e.g. to provide a cartoon effect. In other embodiments, the lip images may be generated from models, e.g. using 3D or 2D digital modelling, to provide synthetic images.

The synthetic images may be generated on-the-fly, or may be pre-stored and recorded, e.g. as animated GIF images, the animation may simulate the movement of real lips during conversation. In some embodiments, the lips images may be based on lips images from celebrities or of fantasy animals or fantasy actors, e.g. to create a novelty effect. In some embodiments, the lips images may be made available as content, e.g. from an app store. In some embodiments, the lips images may be overlayed on face images of the user, e.g. to create a novelty effect or aesthetic effect. The lips images may also be used as part of training, e.g. for learning foreign languages or as coaching for enhancing the sensuousness of the user's appearance. The aforementioned novelty and/or aesthetic effects also contribute to providing information for understanding whisper communications.

FIG. 13 shows examples of real images of real lips enunciating various sounds. The images have been processed to reduce the number of grayscales and an edge detection algorithm has been applied. In FIG. 13, lip photographs are shown together with respective edged detected pictures for sounds A-Z, without the homophones e.g. /k/ and /q/. The sounds /oo/ represent the vowel in the English word ‘school’, and the sound /uu/ represent the French vowel sound in ‘tu’. The edge detection algorithm in FIG. 13 is the Canny edge detection algorithm from the Imagemagick toolkit. The Canny algorithm requires a convolution of the image with a blur kernel, four convolutions of the image with edge detection kernels, gradient calculations, non-maximum suppression and hysteresis threshold processing, resulting in a complexity of O(m n log (m n)) (see https://en.wikipedia.org/wiki/Edge_detection, the contents of which is incorporated herein). However, any edge detection algorithm may be used, e.g. the Sobel, Prewitt, Roberts or fuzzy logic method. The pre-processing may include detecting lip, teeth and tongue features and positions. Colour processing was found to be helpful, e.g. in distinguishing between lips and face skin pixels, or between lips and tongue pixels. The edge profile pictures show how the opening of the mouth and the shaping of the profile is substantially different between phonemes.

The pictures shown in FIG. 13 will be different from one user of the system to the next, and whilst some universal rules may apply, best results should be obtainable by training the system for each user. For specific users, the training algorithm can be used to normalise, e.g. if the user has a gold front tooth, then an adaptive pixel counting algorithm can be accordingly adjusted. User-specific features such as gold teeth or moles may thus be used beneficially as part of the classification process. Alternately or optionally, existing user identification features may be used, or the processing of the present invention may be used as part of user identification which may be more convenient to the user or considered to be more private that a full face recognition software since it is only the lips area that are imaged.

The images of the lips may be sent to the other communicating device in raw digital format, or may be first compressed (e.g. by gray level companding), or representations may be sent as an indexes from a a list of pre-recorded images, or generated on-the-fly as synthetic images, on the capture side, the replay side, or both sides. Facial organs related to the mouth (e.g. lips, teeth, tongue) may be identified and tracked, e.g. by Kalman filtering, particle filtering, unscented filtering, alpha-beta filtering, or moving averages. For example, in FIG. 13, the lips information alone makes distinguishing between /n/ and /k/ phonememes difficult, but by monitoring the lips as well as the tongue and teeth, e.g. by counting tongue pixels and tooth pixels ratios, it is easier to distinguish between the two said phonemes.

The lip reading camera may beneficially use stabilisation techniques, e.g. taking a larger picture than is used for phoneme recognition, and only using a subset of the pixels according to a stabilisation algorithm. The stabilisation algorithm may deduce movements from how the picture moves, and/or from sensors such as the mobile device acceleration sensors. The system may also warn the user (e.g. a flashing indicator) when the lip camera image is not sufficient, e.g. by the user moving their mouth closer or further away from the lips camera. The attitude of the camera may also be deduced from position sensors and/or image information, and the attitude information may be used to further pre-process the lips image, e.g. by normalising by appropriate rotation and zooming, and/or by compensation for ambient lighting conditions.

When the preprocessing of the lips video images includes edge detection algorithms, the classification process may be very similar to OCR (optical character recognition) classification since the edge detected images can be considered similar to alphabetic characters. As a person skilled in the art of OCR will know, recognition methods such as neural networks, convolutional networks, support vector machines, Baeysian inference engines or fuzzic logic inference engines may be used to classify characters. For example, for each character that needs to be identified, one neural network is used, wherein each neural network has as its inputs the pixels of the ‘character’ image, in this invention the ‘character’ image is a lip image from the lip camera, wherein the lip image has been edge detected. In the aforesaid example, each ‘character’ image is thus associated with a separate classification network, and each character image classification network is trained by e.g. modifying the weights of neural network ‘synapses’, that is the same character image/lip image is presented to a number of classifiers for each character that needs to be indentified, and each of the respective classifiers will produce their own output for the image, the output produced being a level of confidence that the particular character is the character that that particular classifier is looking for. In the aforesaid example, a neural network may output a value, e.g. a value between 0 and 1, wherein 1 means that the value that the particular classifier is looking for has been recognised. The tesseract software in Linux can be used to classify character sets from languages such as English by the use of the appropriate font sets. By considering the line feature images in FIG. 13 as the glyphs of a font set, the present invention used existing OCR software as a classification platform for identifying the most appropriate classification algorithms.

In FIG. 14, an embodiment of the lip image classification algorithm is shown. In FIG. 14, item 1410 is a lip image taken by a lip camera. The example shown is the ‘A’ image from FIG. 13, but it may be any image. The purpose of the system is to identify whether the image that is inputted to algorith 1400 is an ‘A’, a ‘B’ etc. The lip image may be processed by preprocessing module 1420 which may include level processing, colour process and feature processing. An example of the feature processing may be recognising teeth, lip, or tongue pixels, and/or edge detection. The output of module 1420 is a features matrix 1430. The features matrix 1430 may be used as the input to the classifier 1440. The output of the classifier may be a vector with a confidence value for each phoneme/letter that needs to be identified. The training of the classifier nodes in 1440 can be performed off-line in a training mode, but can also include default classification options from average users.

Furthermore, an a posteri training can be performed by analysing near-historical data and updating the training modes so as to provide a continuously improving system. The training of 1440 can be combined with training of algorithms in 1420. Furthermore, a speech-to-text means can be integrated with the system 1400 since many of the functions of a speech-to-text system are already present in system 1400.

A phoneme is a unit of sound that can distinguish one word from another in a particular language. As a person skilled in the art would know, phonemes can be described using a phonetic transcription, e.g. the International Phonetic Alphabet (IPA). The IPA includes two principle types of brackets used to delimit IPA transcription, e.g. square brackets [ ] or slashes // or others. For the purpose of this application, slashes are mostly used for phonetics, e.g. the English letter ‘s’ is generally pronounced as /s/. Notwithstanding, throughout this application phonemes and characters/alphabet symbols may be used interchangeably if the meaning can be deduced from the context. In the scientific study of phonology, persons skilled in the art will appreciate that spectrograms are used to study speech. Spectrograms are 2D plots of frequency against time wherein the intensity is shown in the z-axis as a darkening of the plot (heat maps) or as a z-projection in 3D versions of spectrograms. In 2D spectrograms, vertical axis usually represents frequency and the horizontal axis represents time. Since frequency is an inverse time value, it is important to realise that the inverse frequency timescales are at substantially different scales when compared with the horizontal time scales, e.g. a frequency of 10 KHz (inverse is 0.1 milliseconds) in the top range of a plot whilst the horizontal axis may range from 0 to 3 seconds. In this writing, the term ‘slow time’ is used to refer to the horizontal axis of a spectrogram, and the term ‘short time’ is used to refer to the inverse scaling of the vertical axis in a spectrogram. In a spectrogram, the vertical axis already represents the result of a transform-domain, usually an SFFT (Short-time Fast Fourier Transform) which performs FFTs (Fast Fourier Transforms) on chunks of data in the time domain.

When verbal communication conditions are not ideal, e.g. when there is high ambient noise, speech may be blurred. However, the blurring is often occuring in certain patterns, e.g. distinguishing between fricative sounds such as /f/ and /s/ phonemes because fricative sounds have a high bandwidth and when these sounds are bandwidth limited, they become less distinguishable. Fricative phonemes may include whitenoise-type spectra, i.e. filling a wide band with equal energy. The larynx and the mouth/nose cavities have resonant frequencies of their own which are typically lower than the highest frequency components of fricative phonemes. When the speech sound is not voiced, e.g. whispered, the problem can become worse because human brain functions use additional cues to help distinguish between phonemes, e.g. white noise envelope dynamics which may be distorted when the bandwidth of the speech is distorted, e.g. by equalizing signal processing functions. Ambient noise may be removed by using noise-cancelling techniques using the plurality of microphones on the mobile device. The automatic voice enhancement invention of the present application may cooperate and/or be integrated with noise cancelling means on any mobile device.

A trained researcher in phonemics may visually be able to distinguish between an /s/ and and /f/ on a spectrogram, e.g. the /s/ has more spectral components in the higher frequencies than an /f/. Whilst vowels can often be identified by ‘formants’, fricatives can usually be identified by their higher frequency contents, and plosives by there slow time profiles and frequency contents. For further information see (https://home.cc.umanitoba.ca/˜krussll/phonetics/acoustic/spectrogram-sounds.html) and (https://home.cc.umanitoba.ca/˜robh/howto.html), the contents of which are included herein).

The use of spectrogram information in realtime can be problematic because spectrograms based on FFT (fast Fourier transforms) have a non-neglible latency, even on the fastest computers because of the inherent sampling requirements. FFT algorithms can be sped up by using faster processors but are limited then by the sampling rates. Parallel algorithms can also speed up the processing, but the speedup is limited by Amdahl's Law, and for FFT, there is unfortunately a high coupling between the branches of the FFT, whether the FFT be decimate in time or decimate in frequency. Furthermore, parallelising algorithms such as overlap-add and overlap-save work by splitting the FFT processing load in the time domain which is not always suitable for online (real-time) processing. For example, to perform a 1024 point FFT, 1024 time samples are required. By the Nyquist criterion, a frequency range of 0-10 kHz (a realistic human speech range, but 20 kHz is better), sampling has to occur at at least 20 kHz (40 KHz is better). 2048 samples at around 20 kHz is only about 0.1 seconds worth of sampling, whilst may spectrogram phenomena range in the seconds time scale.

Whilst real-time FFT processing is possible (e.g. Wiener processing), it may be advantageous to use the spectrogram information for off-line characterisation of particular speech sounds, and then use simpler infinite impulse response (IIR) or event finite impulse response (FIR) filters to equalise or preemphasize sounds to make them clearer. A person skilled in the art of electronics would know how to design a filter bank of IIR or FIR filters for equalisation. For example, filters of a filterbank can be designed in the analogue domain as Butterworth, Chebychev or Eliptic functions to cover each frequency notch, and then be digitised, e.g. by the Bilinear tranform in order to achieve a set of tapped delays and multiply-add functions. Alternatively, the filters can be designed in the frequency domain by the direct digital design method whereby the frequency domain is expressed as a sample domain, see (https://en.wikipedia.org/wiki/Infinite_impulse_response, https://en.wikipedia.org/wiki/Finite_impulse_response) (https://en.wikipedia.org/wiki/Bilinear_transform) (https://dspguru.com/dsp/faqs/) the contents of which are included herein, all such digital signal processing techniques are core skills in undergraduate digital signal processing courses. In general, IIR response have less ideal phase transfer functions but they have much lower latency and can be implemented using far fewer taps and multiply-add operations when compared to FIR filters. In FIG. 17, item 1710 is such a filterbank/voice signal modifyer with a relatively short processing latency, e.g. 0.1 seconds.

A person skilled in the art of electronic engineering would be aware that a filterbank implemented in software (DSP), programmable hardware (FPGAs) or even in analogue circuitry (op-amps) can be configured with dynamically changeable coefficients that will dynamically change the equalisation profile when the coefficients are dynamically changed. For example, an /f/ sound can be made to sound more like an /s/ sound by emphasizing or adding the high frequencies that distinguis an /f/ from an /s/ sound. Likewise, an unvocalised (i.e. whispered) vowel sound (a-e-i-o-u) may be artificially vocalised by adding or emphasising spectral components. Vowel voicing frequencies can be determined by the shape of the bocal cavity and the lip expression.

In some embodiments, embodiments of the present invention can use images taken from cameras to make the sound captured by the microphone(s) more intelligible. For example, by using image recognition software of the lip images, the system may recognize that there is a higher likelihood of an undistinguishable fricative sound be an /f/ instead of an /s/. For example, in most dialects of English, an /f/ sound is produced by putting the front upper teeth on the bottom lip, whilst an /s/ sound is generally produced with the upper and lower front teeth aligned and with the tongue withdrawn. This means that more teeth pixels (e.g. mostly whitish pixels) may be visible in an image of an /f/ when compared to an /s/, and thus such image information may be used to process sound information. By using machine learning software, the user can put their phone in a training mode, e.g. by recording both a voiced version and an unvoiced (whisper) version of the same sounds of the alphabet or the phoneme list of the particular language. For example, deep learning algorithms such as convolutional neural networks (CNNs) can be used to recognise the likelihood of particular phonemes having been uttered by analysing the lip reading camera's images, or by analysing the historical speech information.

Simple pixel counting algorithms may be used, e.g. by calculating discriminating information between an /s/ and an /f/ by counting the relative number of teeth pixels, or the number of tongue pixels.

Optionally, alternatively or additionally, the system may employ natural language processing (NLP) to predict the likelihood of a sound being an particular phoneme. For example, in English there is a higher likelihood of the word ‘cars’ than ‘carf’ or ‘calf’, especially if words such as ‘many’ preceeded the /karf/kars/ sound. In this application, a priori information used to infer a phoneme based on grammar and/or vocabular is referred to as linguistic a priori phonetic information. In a further example, most English vocabularies include a word ‘fat’ but not a word ‘fot’. Therefore, if it is known that the user is sensible and communicating in English, an unvoiced (whispered) enunciation of the word ‘fat’, e.g. /f3t/, may be processed by the voice enhancement system by emphasizing or adding vowel frequencies for /a/, which may be of a higher pitch than the vowel frequencies for /o/. This adding/emphasizing of the wovel voice frequencies may be performed locally (at the speaker/sender), centrally (at a server) or remotely locally (i.e. at the listener's phone).

Optionally, alternatively or additionally, it is known that most human talkers have limited subsets of vocabulary, and that their vocabulary may be statistically profiled for the age, profession or geographic location. Thus, a farmer's speech may be more likely to include the word ‘calf’ than when compared to a teenager in a city, and in some embodiments, for a farmer in an agricultural setting, the phonemes /kalf/karf/kars/ may be inferred with a higher probability to ‘calf’, whilst for a teenager in a city, the likelihood may be calculated to be higher for ‘cars’. Likewise, distinct natural languages such as English and French have their own phoneme sets and the use of a particular language is part of a user's profile. Thus, it can be seen that historical behaviour profiles, e.g. such as collected by companies such as Google that combine content, geoinformation (e.g. GPS), i.e. profiles of the user as well as profiles of nearby users and profiles of the listening party, can be used to calculate a priori information that can be used to more accurately infer a phoneme. In this writing, such a priori information is referred to as behavioural a priori phonetic information. Thus a prediction coding can be used to predict words, which may be useful anticipate words or phonemes on the fly, either to make a voiced utterance more intelligible or to add voice to an unvoiced (whispered) utterance.

In FIG. 12, examples of stylized lip images are shown, e.g. 1182 for /s/ when not voiced (whispered), or when voiced French /j/, and 1182 for unvoiced (whispered) /f/ or voiced English /v/. By analysing the shape of the lips in FIG. 12, the system may quickly decide (e.g. in a tenth of a second) that a whispered fricative sound is more likely to be either an /s/ or an /f/. Mobile devices have cameras that typically shoots at 24, 30 or 60 frames per second. Moreover, for general video applications, higher digital resolutions are often preferred by consumers, e.g. 1K, 2K or 4K formats. By using a dedicated lips camera, a lower resolution may be used at a high frame rate, e.g. 640×480 pixels (SD) or even lower, but at a high frame rate, e.g. 120 frames per second. When the lips camera information is locally processed, the lips information does not need to increase the communication bandwidth requirements.

Since the lips camera image processing algorithm is ‘looking’ for specific patterns related to a limited set of phonemes, the algorithm may be simplified when compared to other image processing algorithms such as facial recognition algorithms or pure lip-reading algorithms that do not perform sensor fusion with sound information. Textual information may be sent along with the voice information on the telephonic connection so that the whispering can be voiced or displayed at the receiving side.

In FIG. 15, an example spectrogram is illustrated of the present inventor's voice of an /s/ (‘s’) sound. The same voice sample was recorded on a Linux computer with the Linux ‘audio-recorder’ program in a file ‘s.wav’ sampling at 16 bit, mono 22050 Hz. The file ‘s.wav’ is plotted twice for the purpose of clarity. FIG. 15(a) (top plot) shows the ‘s. wav’ file plotted with the Linux ‘sox’ program. The same ‘s.wav’ file is plotted in FIG. 15(b) (bottom plot) with the Linux ‘spek’ program, in colour. The /s/ sound starts at about 0.9 s (x-axis), and continues until about 2 s on both the top and bottom spectrogram plots. The y-axis legend on the left indicates frequency (0-11 kHz). The right legend is the intensity (power) legend. The power legend on the top spectrogram plot goes from −100 to 0 dBFS (dB full scale). The power legend on the bottom spectrogram goes from −120 dBFS to −20 dBFS, hence the difference in the intensity of the two spectrogram plots. The period between 0.9 s and 2 s shows a spectrum consisting largely of white noise (i.e. constant power between 0 and 11 kHz) because of the fricative nature of an /s/ sound, except that the spectral components between 6 kHz and 11 kHz show a 40 dB increase.

In FIG. 16, an example spectrogram is shown of the present inventor's voice of an /f/ (‘f’) sound using the same recording and plotting arrangement as above for a file ‘f.wav’. Likewise, the top (a) spectrogram was the ‘f.wav’ file plotted using the Linux ‘sox’ program, and the bottom (b) spectrogram was same file plotted using the Linux ‘sox’ program. The /f/ sound can be seen to occur between about 0.75 s and 2 s on the time scale. When colour is available, intensity differences are more clear. The /f/ spectrogram shows a similar white noise type spectrum between 0 and 11 kHz, with an exception in the form of more spectral energy between 0 and 1 kHz. However, this spectral band increase is thought to be due to resonance in the environment. Notwithstanding, it can be seen that between about 1 kHz and 6 kHz, the spectra of FIG. 15 and FIG. 16 look very similar.

In many telephone communication systems and standards, voice bandwidth are limited between about 500 Hz and 4 kHz or less, although between 1 kHz and 6 kHz. Classic voice bandwidth on telephones used to be about 3.4 kHz which is about 7 kHz PESQ (perseptual evaluation of speech quality) bandwidth as set by ITU standards. With such a bandwidth limit, it is understandable why it is difficult to distinguish between /s/ anf /f/ sounds and why users often resort to using the phonetic alphabet when spelling is important, e.g. when telling someone an email address over the phone, e.g. spelling out ‘sierra’ and ‘foxtrot’ instead of pronouncing /s/ and /f/ in order to avoid mistakes. In FIG. 18a-c, similar /f/ and /s/ sounds were recorded for a longer period, equalized to similar average levels and bandlimited to between 1 and 4 kHz to simulate the limited bandwidth of a telephony system, using the Linux ‘sox’ command. The bandwidth-limited /f/ and /s/ sounds (FIG. 18(a) and (b)) were mixed to produce an ambiguous sound in FIG. 18(c).

For each of the /f/ and /s/ sounds, a characteristic noise signal was extracted (FIGS. 19(a) and (b) respectively. By then adding (i.e. mixing with the sox command) the respective characteristic noise signals to the ambiguous signal, respective synthetic /f/ and /s/ sounds as shown in FIGS. 20A(a) and (b) are shown. Likewise, a voiced and unvoiced /a/ sound were recorded and shown in FIGS. 20B(a) and (b) respectively. By extracting characteristic signals as shown in FIG. 20C(a), a synthetic voiced /a/ sound can be produced as shown in FIG. 20C(b). Thus, elements of human speech can be ehanced by mixing the original sounds with other sounds. The quality of the resulting synthetically voiced sound can be subjective and can optionally be tuned to the user's liking in a customisation phase wherein the user will adjust the weights of the mixing process by trial and error to their liking. It is also envisaged that users may use sound clips from a library or from a store to enhance their voice, e.g. by using elements of voices from celebrities. Optionally, the voice elements may be extracted from stored voice tracks, e.g. from songs or from podcasts and used to enhance the user's voice. Optionally, the voice enhancement may be used to thwart voice recognition systems such as those that are used to track users and which are considered to be an invasion of privacy by many users.

The extracted characteristic noise signals may be generated by modules 1720, 1730 in FIG. 17 and mixed by mixing/equalizing module 1710 that enhances the voice signal from the microphone 1180, according to information received by the lip camera 1170. White noise and pink noise may be used that are filtered by band-pass filters to obtain characteristic noise signals appropriate to particular phonemes. Alternatively or optionally, characteristic noise signals for each voiced phoneme may be stored an used to generate the noise for each phoneme that can be added to unvoiced phonemes.

In FIG. 21, a block diagram of a computer system is shown that may be used to implement features of some embodiments of the disclosed invention. In FIG. 21, the computer system 2100 may comprise one or more units that are connected via an interconnect 2110. The interconnect may be any interconnect as known to the person skilled in the art, for example any version of a Industry Standard Architecture (ISA) bus, a Peripheral Component Interconnect (PCI) bus, a universal serial bus (USB), an Inter-Intergrated Circuit (I2C) bus, a Local Area Network (LAN), or a wireless bus. The units may include a processor 2120, a memory (storage) 2130, input/output units 2140, (long-term) storage units 2150 and network adapters 2160. The computer system may be a custom circuit or an industry-standard circuit, e.g. an ARM™, RISKV™, or Intel™ x86 compatible processor. The network adaptor may be a LAN adapter (e.g. a WiFi™ adaptor) or a digital communications network such as a 2G, 3G, 4G, 5G or other such communications networks. The image formats may include image formats such as PNG, JPEG, JPEG2000, GIF (including animated GIF) formats, as well as video formats such as H.262, H.263, H.264, H.265 or any related or similar formats, including any of the MPEG formats, or any still image formats that are shown rapidly in a sequence. The computer systems disclosed in this application may run software natively or may use an operating system, e.g. Android™, Linux™, IOS™, OSX™, Sailfish™, Zephyr™, VxWorks™, Windows™, Windows CE™, MQX™, LiteOS™, LynxOS™, RTX™, RTLinux™, UNIX™, POSIX™, freeRTOS™ or any other operating system.

The modules disclosed in this application can be implemented by, for example, using software and/or firmware to program programmable circuitry (e.g. microprocessor), or entirely in bespoke hardwired (non-programmable) circuitry, or in a combination of such forms. Bespoke hardwired circuitry may be in the form of, for example, one or more FPGA, PLDs, ASICs, system-on-chip (SIC), etc.

In this specification, the term ‘embodiment’ means that a specific feature described relating to an embodiment is encluded in at least one embodiment and specific references to an ‘embodiment’ does not imply that all such references refer to the same ‘embodiment’. All examples provided in this specification are illustrative only and it is not intented to limit the scope and meaning of the disclosures. Persons skilled in the art will appreciate that the programs and flow diagrams provided in this application may be performed in series or in parallel or in a combination thereof, and may be performed on any type of computer.

The scope sought by the present application is not to be limited solely by the disclosures herein but has to be broadened in the spirit of the present disclosures. In the present application, the term ‘comprise’ is not intended to be construed as limiting and the disclosure of any reference should not be construed as admitting anticipation. All patents, applications and citations referred to in this description are recursively included herein in their entirety.

1-33. (canceled)

34. A method comprising: capturing elements of whisper communication expressed by a first user and converting the elements of whisper communication into signals suitable for transmission over a communications network; transmitting the signals over the communication network; receiving the signals and reconverting the signals into elements of whisper communication and replaying the whisper communication such that it can be perceived by a second user; wherein the elements of whisper communication comprise sound information associated with phonemes of speech and image information of facial organs associated with phonemes of speech.

35. The method as defined in claim 34, wherein the capturing and converting is performed by means comprising at least one whisper sound microphone and at least one lips video camera;
wherein the reconverting is performed by means comprising at least a whisper sound reproduction device and a lips display device; wherein the whisper sound microphone, the lips video camera, the whisper sound replay device and the lips display device are whisper features of a mobile telephone.

36. The method as defined in claim 35, wherein the lips video camera is located substantially near the at least one whisper sound microphone; wherein the lips video camera substantially captures only a mouth area of the first user when the mobile telephone is held in a normal position with a top portion of the phone close to the first user's ear and a bottom portion of the phone close to the first user's mouth.

37. The method as defined in claim 35, wherein the whisper sound replay device is an extendable earphone fixedly attached to the mobile telephone.

38. The method as defined in claim 35, wherein the whisper sound replay device is a bone conduction device.

39. The method as defined in claim 35, wherein images from the lips video camera are processed to identify phonemes from the shape of the mouth of the first user.

40. The method as defined in claim 35, wherein the signals are equalized by digital filtering and sound mixing for disambiguation of the transmitted whisper communication.

41. An electronic device for whisper communication, comprising: a means for capturing elements of whisper communication expressed by a first user and converting the elements of whisper communication into signals suitable for transmission over a communication network; a means for transmitting the signals over the communication network; a means for receiving the signals and reconverting the signals into elements of whisper communication and replaying the whisper communication such that it can be perceived by a second user; wherein the elements of whisper communication comprise sound information associated with phonemes of speech and image information of facial organs associated with phonemes of speech.

42. The device as defined in claim 41, wherein the capturing and converting is performed by means comprising at least one whisper sound microphone and at least one lips video camera; wherein the reconverting is performed by means comprising at least a whisper sound reproduction device and a lips display device; wherein the whisper sound microphone, the lips video camera, the whisper sound replay device and the lips display device are whisper features of a mobile telephone.

43. The device as defined in claim 42, wherein the lips video camera is located substantially near the at least one whisper sound microphone; wherein the lips video camera substantially captures only a mouth area of the first user when the mobile telephone is held in a normal position with a top portion of the phone close to the first user's ear and a bottom portion of the phone close to the first user's mouth.

44. The device as defined in claim 42, wherein the whisper sound replay device is an extendable earphone fixedly attached to the mobile telephone.

45. The device as defined in claim 42, wherein the whisper sound replay device is a bone conduction device.

46. The device as defined in claim 42, wherein images from the lips video camera are processed to identify phonemes from the shape of the mouth of the first user.

47. The device as defined in claim 42, wherein the signals are equalized by digital filtering and sound mixing for disambiguation of the transmitted whisper communication.

48. A non-transitory computer-readable storage medium storing computer-executable instructions that when executed by one or more processors, configure the one or more processors to perform operations comprising: capturing elements of whisper communication expressed by a first user and converting the elements of whisper communication into signals suitable for transmission over a communication network; transmitting the signals over the communication network; receiving the signals and reconverting the signals into elements of whisper communication and replaying the whisper communication such that it can be perceived by a second user; wherein the elements of whisper communication comprise sound information associated with phonemes of speech and image information of facial organs associated with phonemes of speech.

49. The storage medium as defined in claim 48, wherein the capturing and converting is performed by means comprising at least one whisper sound microphone and at least one lips video camera; wherein the reconverting is performed by means comprising at least a whisper sound reproduction device and a lips display device; wherein the whisper sound microphone, the lips video camera, the whisper sound replay device and the lips display device are whisper features of a mobile telephone.

50. The storage medium as defined in claim 49, wherein the lips video camera is located substantially near the at least one whisper sound microphone; wherein the lips video camera substantially captures only a mouth area of the first user when the mobile telephone is held in a normal position with a top portion of the phone close to the first user's ear and a bottom portion of the phone close to the first user's mouth.

51. The storage medium as defined in claim 49, wherein the whisper sound replay device is an extendable earphone fixedly attached to the mobile telephone.

52. The storage medium as defined in claim 49, wherein the whisper sound replay device is a bone conduction device.

53. The storage medium as defined in claim 49, wherein images from the lips video camera are processed to identify phonemes from the shape of the mouth of the first user.

54. The storage medium as defined in claim 49, wherein the signals are equalized by digital filtering and sound mixing for disambiguation of the transmitted whisper communication.
